(19) United States
(12) Patent Application Publication
(10) Pub. No.: US 2025/0185633 A1
(43) Pub. Date: Jun. 12, 2025

(54) METHOD FOR AQUACULTURE MONITORING WHITESHRIMP BASED ON MULTIMODAL DATA FUSION

(71) Applicant: Zhejiang Wanli University, Ningbo (CN)

(72) Inventors: Shaozhong Zhang, Ningbo (CN); Dingkai Zhang, Ningbo (CN); Pengfei Shao, Ningbo (CN)

(21) Appl. No.: 18/943,925

(22) Filed: Nov. 12, 2024

(30) Foreign Application Priority Data
Dec. 8, 2023 (CN) 202311680919.5

(51) Int. Cl. A01K 61/59; G06V 10/80; G06V 10/82; G06V 40/10

(52) U.S. Cl. CPC A01K 61/59; G06V 10/806; G06V 10/82; G06V 40/10

(57) ABSTRACT

A method for aquaculture monitoring whiteshrimp based on multimodal data fusion includes following steps. A dataset is collected, the dataset includes: aquaculture environment data and whiteshrimp images. The dataset is extracted to obtain features of the whiteshrimp images and features of the aquaculture environment data, followed by performing feature fusion between the features of the whiteshrimp images and the features of the aquaculture environment data, thereby obtaining multimodal fusion features. A shrimp aquaculture monitoring model is constructed based on the fusion features by using a Bayesian network model. A shrimp aquaculture is monitored based on the shrimp aquaculture monitoring model. The method realizes the monitoring and early warning of shrimp aquaculture, which provides guidance for the development and adjustment of aquaculture plans, improve the efficiency of shrimp aquaculture, and reduce mortality rates.

### TECHNICAL FIELD

The disclosure relates to the technical field of cultivation, and particularly to a method for aquaculture monitoring whiteshrimp (i.e., Litopenaeus vannamei) based on multimodal data fusion.

### BACKGROUND

Intelligent shrimp aquaculture is an important technique and method in the field of aquaculture. In recent years, many methods have utilized technologies such as the Internet of Things (IoT), big data, and artificial intelligence to propose a series of intelligent shrimp aquaculture methods.

The methods of the intelligent shrimp aquaculture mainly focus on an intelligent aquaculture monitoring system, an intelligent aquaculture management system, and an intelligent aquaculture early warning system. The key point is the intelligent monitoring system for the shrimp aquaculture, aiming to achieve real-time monitoring and data analysis of important parameters such as temperature, dissolved oxygen, and hydrogen ion concentration (pH) in shrimp aquaculture water quality.

Intelligent methods in the field of the shrimp aquaculture mainly focus on an automated aquaculture system, an intelligent aquaculture environment regulation system, and a data-driven shrimp aquaculture management system. The main focus is to integrate information related to shrimp aquaculture, including: acoustic monitoring information of shrimp, biomass counting information in shrimp aquaculture using image processing technology, and estimating the yield information of shrimp farms through remote sensing images.

However, there are still some problems with existing shrimp aquaculture management techniques and aquaculture environment monitoring, mainly reflected as follows.
(1) Most methods in the related art focus on the monitoring and control of various water quality indicators in aquaculture, with less integration of multiple environmental indicators related to the aquaculture environment for comprehensive analysis.
(2) The most methods in the related art focus on the collection and analysis of aquaculture environment data, and there is still a lack of intelligent causal or correlation analysis among environmental factors, the growth, activity, and health status of shrimp. Although IoT technology can already achieve monitoring of the aquaculture environment, the logical and causal relationships among the aquaculture environment, the growth and health of shrimp still need to rely on human experience. There is a lack of systematic, knowledge-based, and intelligent approaches to the logical and causal relationships among the aquaculture environment, the growth and health of shrimp.

### SUMMARY

In order to solve above problems, the disclosure provides a method for aquaculture monitoring whiteshrimp based on multimodal data fusion.

The method for aquaculture monitoring whiteshrimp (i.e., Litopenaeus vannamei) based on multimodal data fusion includes:
a dataset is collected, the dataset includes: aquaculture environment data and whiteshrimp images, the whiteshrimp images include whiteshrimp individual images and whiteshrimp group images, each of the whiteshrimp individual images contains one whiteshrimp, and each of the whiteshrimp group images contains at least two whiteshrimps;
the dataset is extracted to obtain features of the whiteshrimp images and features of the aquaculture environment data, followed by performing feature fusion on the features of the whiteshrimp images and the features of the aquaculture environment data, thereby to obtain multimodal fusion features;
a shrimp aquaculture monitoring model is constructed based on the multimodal fusion features by using a Bayesian network model; and
shrimp aquaculture conditions are monitored based on the shrimp aquaculture monitoring model.

In an embodiment, shrimp aquaculture conditions include water quality parameters and meteorological parameters. The water quality parameters include a water temperature, a dissolved oxygen content, a hydrogen ion concentration (pH) value, ammonia nitrogen and nitrate levels, and a turbidity. The meteorological parameters include an air temperature, an air pressure, and a humidity.

In an embodiment, an intelligent aquaculture monitoring system includes a processor and a memory. The memory is configured to store computer executable instructions executable by the processor, and the processor is configured to execute the computer executable instructions to implement the method.

In an embodiment, the shrimp aquaculture conditions include a water quality condition and a meteorological condition.

In an embodiment, the intelligent aquaculture monitoring system is connected to a temperature control device, the temperature control device is configured to adjust the water temperature, and the monitoring shrimp aquaculture conditions based on the shrimp aquaculture monitoring model includes:
generating an early warning signal by the intelligent aquaculture monitoring system, in respond to the water temperature not being in a range of 25° C. to 30° C., then controlling the temperature control device by the intelligent aquaculture monitoring system to adjust the water temperature being in the range of 25° C. to 30° C. The temperature control device in the disclosure is not limited to this.

In an embodiment, the intelligent aquaculture monitoring system is connected to an aerating device, the aerating device is configured to adjust the dissolved oxygen content, and the monitoring shrimp aquaculture conditions based on the shrimp aquaculture monitoring model includes:
generating an early warning signal by the intelligent aquaculture monitoring system, in respond to the dissolved oxygen content not being in a range of 5 mg/L to 8 mg/L, then controlling the aerating device by the intelligent aquaculture monitoring system to adjust the dissolved oxygen content being in the range of 5 mg/L to 8 mg/L.

In an embodiment, the intelligent aquaculture monitoring system is connected to a pH regulator, the PH regulator is configured to adjust the pH value, and the monitoring shrimp aquaculture conditions based on the shrimp aquaculture monitoring model includes:
generating a first early warning signal by the intelligent aquaculture monitoring system, in respond to the pH value being lower than 7.5, then controlling the pH regulator by the intelligent aquaculture monitoring system to add lime or calcium carbonate to adjust the pH value being in a range of 7.5 to 8.5, or generating a second early warning signal by the intelligent aquaculture monitoring system, in respond to the pH value being greater than 8.5, then controlling the pH regulator by the intelligent aquaculture monitoring system to add an acidic substance such as aluminum sulfate to adjust the pH value being in the range of 7.5 to 8.5.

In an embodiment, the aquaculture environment data includes water quality parameters (parameters of the water quality condition) and meteorological parameters (parameters of the meteorological condition). The water quality parameters include a water temperature, a dissolved oxygen content, a pH value, ammonia nitrogen and nitrate levels, and a turbidity, and the meteorological parameters include an air temperature, an air pressure, and a humidity.

In an embodiment, the extracting the dataset to obtain features of the whiteshrimp images and features of the aquaculture environment data further includes preprocessing the dataset, and the preprocessing the dataset includes: performing data cleaning, missing value processing, and format converting on the dataset.

In an embodiment, the performing feature fusion on the features of the whiteshrimp images and the features of the aquaculture environment data to obtain multimodal fusion features includes: fusing the features of the whiteshrimp images and the features of the aquaculture environment data based on a multi-layer perceptron (MLP) method.

In an embodiment, the extracting the dataset to obtain features of the whiteshrimp images includes: extracting the dataset by using a deep convolutional neural network to obtain the whiteshrimp individual images and the whiteshrimp group images.

In an embodiment, the extracting the dataset to features of the aquaculture environment data includes extracting the dataset to obtain the features of the aquaculture environment data by using principal a component analysis and wavelet thresholding method.

In an embodiment, the constructing a shrimp aquaculture monitoring model based on the multimodal fusion features by using a Bayesian network model includes:
determining an input data, including: using the multimodal fusion features as the input data for model training;
analyzing and determining network nodes and connecting edges of the Bayesian network model based on expert knowledge and the input data, thereby obtaining a topology of the Bayesian network model;
estimating parameters of the Bayesian network model by using maximum a posteriori method; and
optimizing the topology and the parameters of the Bayesian network model to obtain the shrimp aquaculture monitoring model.

The beneficial effects of the disclosure are as follows.

The disclosure simultaneously collects multimodal data on the aquaculture environment and the activity and growth status of the whiteshrimp. By effectively extracting multimodal features and utilizing deep learning techniques to achieve multimodal feature fusion, a monitoring model based on Bayesian network model is constructed in conjunction with domain expert knowledge and machine learning techniques. The Bayesian network model is used to monitor and provide early warnings for the shrimp aquaculture, thereby enabling the formulation and adjustment of aquaculture plans, improving shrimp aquaculture efficiency, and reducing mortality rates.

### BRIEF DESCRIPTION OF DRAWINGS

The drawings generally illustrate various embodiments by way of example rather than limitation, and are used together with the description and claims to explain the embodiments of the disclosure. When appropriate, the same reference numerals are used in all drawings to refer to the same or similar parts. Such embodiments are illustrative and are not intended to be exhaustive or exclusive embodiments of the device or method.

FIG. 1 illustrates a framework diagram of a method for aquaculture monitoring whiteshrimp based on multimodal data fusion in the disclosure.

FIG. 2 illustrates a schematic diagram of extracted features of the whiteshrimp images in the disclosure.

FIG. 3 illustrates a schematic diagram of extracted features of the aquaculture environment data in the disclosure.

FIG. 4 illustrates a schematic diagram of multimodal fusion features of the features of the whiteshrimp images and water quality data based on a multi-layer perceptron method in the disclosure.

### DETAILED DESCRIPTION OF EMBODIMENTS

It should be noted that the embodiments and features in the embodiments of the disclosure can be combined with each other without conflict. Below, the disclosure will be described in detail with reference to the attached drawings and in conjunction with embodiments.

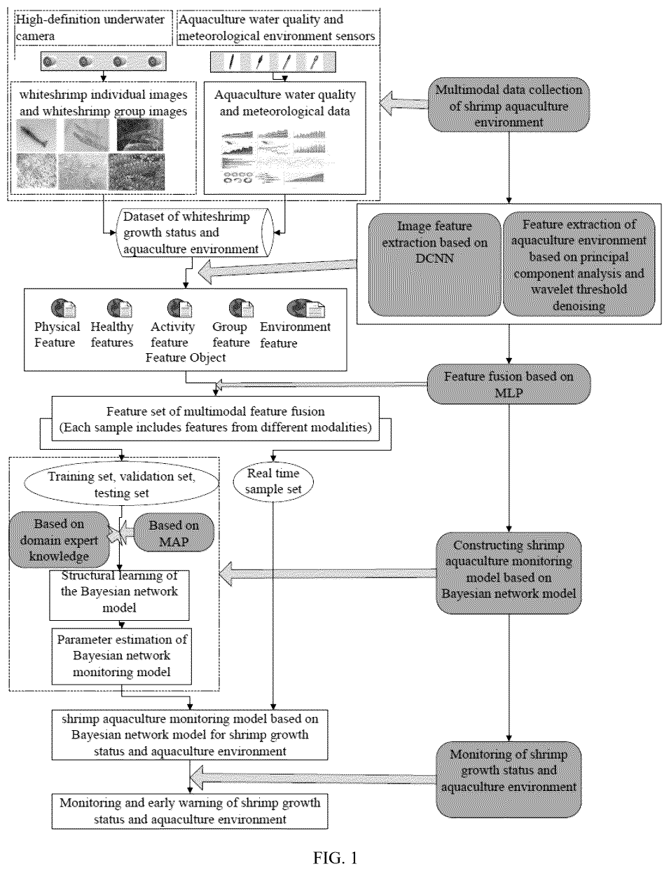

As shown in FIG. 1, a method for aquaculture monitoring whiteshrimp based on multimodal data fusion is provided. The method includes collecting dataset, extracting growth and activities features from whiteshrimp images of whiteshrimp individual images and whiteshrimp group images, aquaculture water quality data, and meteorological environmental data related to the aquaculture environment data, thereby to obtain multimodal fusion features for a shrimp aquaculture. By effectively fusing the features of the whiteshrimp images and the features of the aquaculture water quality data and the meteorological environmental data, the multimodal fusion features for shrimp aquaculture monitoring are achieved. Bayesian network learning technology (Bayesian network model) is used to construct a monitoring model for shrimp aquaculture. With the aid of the monitoring model, intelligent monitoring and early warning of shrimp aquaculture can be realized.

### Data Collection for Shrimp Aquaculture

High-definition underwater cameras are used to collect whiteshrimp images of the growth process, status, and activities of individual whiteshrimp and whiteshrimp group from multiple angles and locations. A Water temperature sensor, a dissolved oxygen sensor, a pH sensor, an ammonia nitrogen sensor, a nitrate sensor, and a turbidity sensor are used to collect various types and multi-site water quality data from a whiteshrimp pond. An air pressure sensor, an air temperature sensor, and a relative humidity sensor are used in combination with data on atmospheric temperature and humidity in the area to collect meteorological aquaculture environment data. The data from the above three sources of the whiteshrimp images, the water quality parameters and meteorological parameters are processed and stored to form a multimodal dataset for the shrimp aquaculture.

The multimodal dataset is extracted to obtain features of the whiteshrimp images and features of the aquaculture environment data, followed by performing feature fusion on the features of the whiteshrimp images and the features of the aquaculture environment, thereby to obtain multimodal fusion features.

### Extracting Feature of Growth Activities of the Whiteshrimp Images

Computer vision and image processing technologies are used to process and analyze whiteshrimp individual images and whiteshrimp group images, key features are extracted such as a size, a shape, a color of individual whiteshrimp, and densities and distribution of whiteshrimp groups. Through the processing and analysis, various feature information objects are formed, such as the morphological and behavioral features of the individual whiteshrimp, and the activity and social features of the whiteshrimp groups. These features are represented by feature vectors.

Deep convolutional neural networks (DCNN) are utilized to extract high-level semantic features of the whiteshrimp images from underwater. Sparse coding (SC) is then applied to further refine the high-level semantic features into sparse representation features. A support vector machine (SVM) is used for classifier training and target recognition.

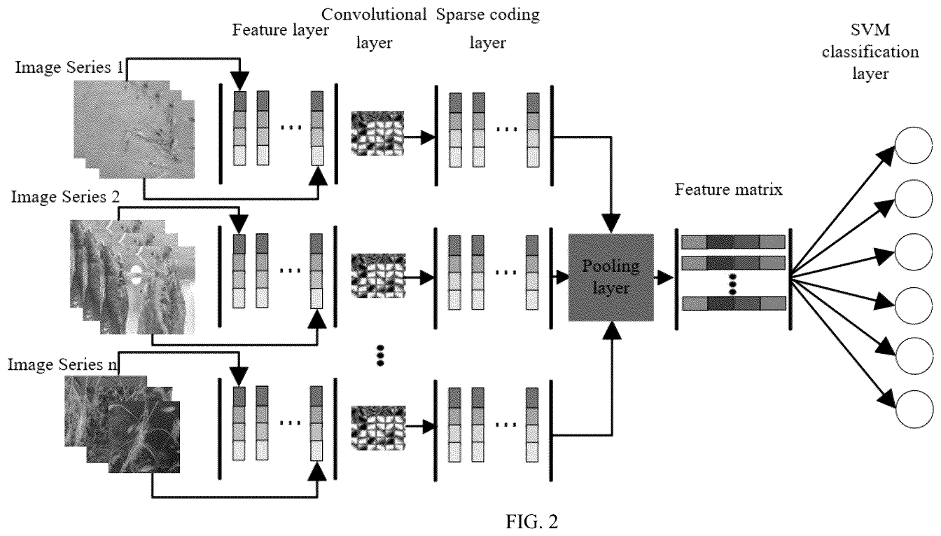

DCNN can automatically extract the high-level semantic features from raw images. In the whiteshrimp images, features such as the morphology, color, and texture of whiteshrimps can be extracted from the whiteshrimp images. SC is a technique used for signal processing and feature extraction, which can further refine the sparse representation features from the high-level semantic features. In the whiteshrimp images, SC can be used to further extract key features of the whiteshrimps from the high-level semantic features. SVM can construct classifiers through training data, achieving recognition and classification of targets. In the whiteshrimp images, SVM can be used for classifier training to recognize the growth and activity of individual whiteshrimp and the whiteshrimp groups. The technical solution is shown in FIG. 2.

Using the above technologies, it is possible to extract and fuse the high-level semantic features, the sparse representation features, and target classification information from the whiteshrimp images, achieving accurate recognition and classification of the growth and activity of individual whiteshrimp and the whiteshrimp groups. Additionally, the technology can also handle issues such as noise, occlusion, and lighting variations in the whiteshrimp images, thereby improving the accuracy and robustness of target recognition.

### Extracting Features of Aquaculture Water Quality Data and Surrounding Meteorological Environment Data

The collected dataset of the aquaculture water quality and surrounding meteorological environmental is processed and analyzed, key features such as the water temperature, the dissolved oxygen, the turbidity, the pH value, and the air pressure are extracted to construct a feature vector set of the aquaculture water quality and the surrounding meteorological environment during the growth process of the whiteshrimp. The features extraction of the water quality and the meteorological mainly uses statistical analysis and digital signal processing techniques. By filtering, noise reduction, and waveform analysis, the collected dataset of aquaculture environmental monitoring is processed and analyzed to extract the key features of the aquaculture environment data. Statistical analysis includes cluster analysis, principal component analysis, and regression analysis, which are used to extract representative features from the data of the aquaculture environmental monitoring and form feature vectors.

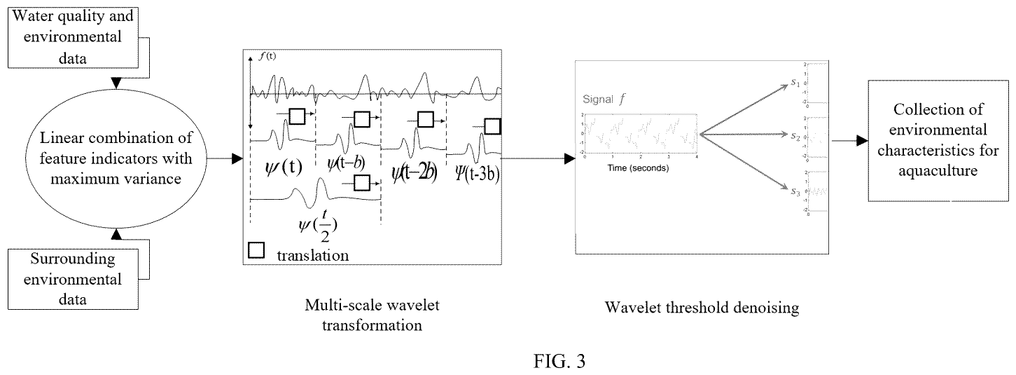

The feature extraction of the aquaculture water quality monitoring data and the surrounding meteorological environmental monitoring data uses a combination of principal component analysis (PCA) and wavelet threshold denoising (WTD), as shown in FIG. 3. PCA maps the original data into a new low-dimensional space where the dimensions are uncorrelated. In the aquaculture water quality monitoring data, six water quality indicators such as a water temperature, a dissolved oxygen content, a hydrogen ion concentration (pH) value, ammonia nitrogen and nitrate levels, and a turbidity are selected. In the relevant meteorological environmental monitoring data, three environmental indicators of air temperature, air pressure, and humidity are chosen. The data processed with PCA can reduce these multiple indicators to a few dimensions to achieve the feature extraction and dimensionality reduction. This is done by standardizing the data, calculating the covariance matrix of the data, performing eigenvalue decomposition on the covariance matrix to obtain the eigenvalues and eigenvectors, forming a new feature space, and then the original data is projected onto the new feature space to obtain the reduced-dimensional data.

In order to remove noise from monitoring data and enhance the robustness of data features, a wavelet threshold denoising is used during the feature extraction process to decompose the data into frequency domain components at different scales. By performing wavelet decomposition on the original data, setting a threshold, filtering and trimming the decomposed wavelet coefficients, and then reconstructing the wavelet to process the original data, a denoised data is obtained. The comprehensive use of PCA and WTD can filter out noise and redundant information from the monitoring data, thereby extracting the information of the key features.

### Performing Feature Fusion on the Features of the Whiteshrimp Images and the Features of the Aquaculture Environment Data

The multilayer perceptron (MLP) is a feedforward neural network model with strong learning and approximation capabilities. In the disclosure, the method based on the MLP is used to integrate and model the features of the whiteshrimp images with the features of the comprehensive aquaculture environment data. The features of the whiteshrimp images are extracted using image recognition technology, resulting in a vector that includes multiple feature dimensions. In addition, the various indicators of the comprehensive aquaculture environment data are used as feature dimensions to form another feature vector. Then, the features of the whiteshrimp images and the features of the comprehensive aquaculture environment data from the two input layers are fused together through some transformation or combination, thereby forming a new input layer that serves as the input for the MLP learning algorithm. One or more hidden layers are designed, the number of neurons and activation functions are chosen according to a complexity of the data, and the appropriate output vector and loss function are selected based on the general indicators for whiteshrimp monitoring.

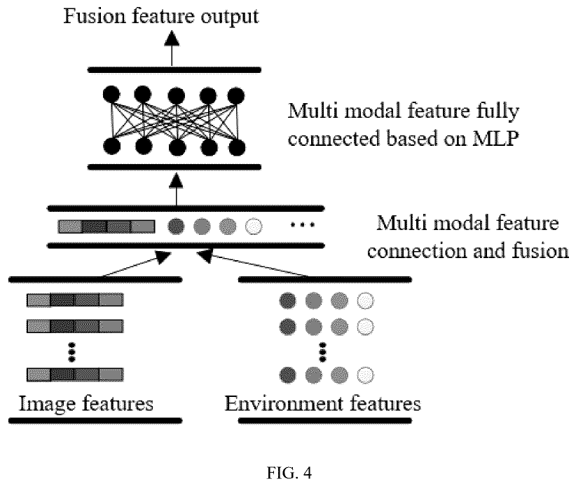

The water quality features and related environmental features in the aquaculture environment data are represented by common type of data, and the feature data of the whiteshrimp images is another type of data. Therefore, features of the whiteshrimp images and features of the comprehensive aquaculture environment data are different data modalities, and it is necessary to fuse the features of the whiteshrimp images and features of the comprehensive aquaculture environment data. The disclosure uses a deep learning based on MLP to achieve the fusion of the features of the whiteshrimp images and features of the comprehensive aquaculture environment data, as shown in FIG. 4.

The basic idea of using MLP for feature fusion is to add several intermediate layers between the input and output layers and establish weight connections between the intermediate layers, thereby integrating information from different features. When fusing features of the whiteshrimp images and features of the water quality data, the two types of features are first input into different neural networks for separate processing and learning. Then, the outputs of the intermediate layers of the two neural networks are combined into a feature vector, which is input into a new neural network for training and classification. The new neural network is commonly referred to as a “fully connected layer” or “classifier”, and is used to transform the feature vector into a final classification result. The characteristic of the MLP is its ability to handle nonlinear problems, and the complexity of the model can be adjusted by changing the number of nodes and layers in the intermediate layers. The training process of the MLP typically uses backpropagation algorithms for optimization to minimize the loss function and update weight parameters.

### Constructing a Shrimp Aquaculture Monitoring Model Based on the Multimodal Fusion Features by Using a Bayesian Network Model

The shrimp aquaculture monitoring model based on the multimodal fusion features is constructed by using a Bayesian network model for model learning and optimization, which includes the following four steps.

### (1) Determining an Input Data

The multimodal fusion features are used as the input data for model training. These features include the growth features of the whiteshrimps, the features of the aquaculture water quality data, and the features of the meteorological environment data. The dataset needs to be ensured to includes observational values of the whiteshrimp and other environmental factors.

### (2) Structural Learning of the Bayesian Network Model

The network nodes and the connecting edges of the Bayesian network model are determined and analyzed based on expert knowledge and the input data, each network node represents a feature or variable, and the edges between nodes indicate the probabilistic dependency relationships between them, thereby obtaining a topology structure of the Bayesian network model.

The Bayesian measure is adopted to fully integrate prior knowledge in the topology structure. The prior knowledge comes from the expert knowledge, variables related to the shrimp aquaculture monitoring model based on the Bayesian network model, such as growth status, health status, water temperature, dissolved oxygen concentration are determined, and the expert knowledge is used to determine the causal relationships or correlations between these variables.

The prior knowledge of the topology structure is represented as a prior probability p(S). Bayes rule is used, when given a training sample set D, a posterior probability of the topology structure S is calculated as follows:

$${Score}_{BDE} ( S : D ) = P ( S \vert D ) = \frac{p ( D \vert S ) p ( S )}{p ( D )}$$

### (3) Parameter Estimation of the Bayesian Network Model

Parameters of the Bayesian network model are estimated through maximum a posteriori (MAP). Given the topology structure S and the training sample set D, the Bayesian posterior probability is denoted as p(θ|D, S). The parameter estimation of the Bayesian network model \hat{θ} using the MAP can be expressed as:

$$\hat{θ} = arg {max}_{θ} p ( θ \vert D , S )$$

according to Bayes rule, the posterior probability of the topology structure S is calculated as follows:

$$p ( θ \vert D , S ) = \frac{p ( D \vert S , θ ) \times p ( θ \vert S )}{p ( D \vert S )}$$

where p(θ|D,S) represents the posterior probability, p(D|S, θ) represents a likelihood function, p(θ|S) represents the prior probability, and p(DIS) represents a constant once S is determined.

### (4) Optimization of the Bayesian Network Model

Through the structure learning and parameter estimation of the Bayesian network model, a shrimp aquaculture monitoring model can be preliminarily established. Additionally, it is necessary to further optimize the shrimp aquaculture monitoring model to improve its stability and generalization performance.

In the shrimp aquaculture monitoring model based on the Bayesian network model of the disclosure, a regularization method is used to optimize the parameters of the shrimp aquaculture monitoring model. The main method involves introducing additional penalties for the parameters of the shrimp aquaculture monitoring model to prevent overfitting.

In the shrimp aquaculture monitoring model based on the Bayesian network model, a regularization term is added to the likelihood function, which is represented in logarithmic form, and then a modified function is used as an objective function expressed as follows:

$$objective function = log p ( θ \vert D , S ) = log P ( D \vert S , θ ) + log P ( θ \vert S ) - log P ( D \vert S )$$

Since log P(D|S) is constant with respect to parameter optimization when the topology structure remains unchanged and S is fixed, it can be ignored. Therefore, a final objective function is expressed as follows:

$$the final objective function = log P ( D \vert S , θ ) + log P ( θ \vert S )$$

The final objective function includes both a likelihood term and a regularization term, where log P(D|S,θ) represents a model's fit to an observed data, and log P(θ|S) represents the prior probability of the parameters. By optimizing the final objective function, the shrimp aquaculture monitoring model based on the Bayesian network model can be obtained that fits the data well without overfitting.

### Monitoring of the Whiteshrimp Growth Status and the Aquaculture Environment

On the basis of the Bayesian network model, the trained shrimp aquaculture monitoring model can be used to predict potential impact factors of the water quality and the surrounding environment on the growth and health of the whiteshrimps.

Data Collection: new water quality data, surrounding environmental data, and relevant observational data of the whiteshrimp are collected (i.e., the dataset is collected). These data should include water quality parameters (such as temperature, dissolved oxygen, pH value), meteorological data (such as air temperature, air pressure, humidity), and relevant features of the whiteshrimp (such as quantity, size, behavior, diseases).

Data Preprocessing and Featureization: a preprocessing is performed on the collected data, which includes data cleaning, missing value processing, and format converting, to ensure that the data is consistent with the input variables of the shrimp aquaculture monitoring model based on the Bayesian network model. Feature extraction and feature fusion are carried out using the methods described above.

Model Loading: the previously trained shrimp aquaculture monitoring model based on the Bayesian network model is loaded, which includes conditional probability relationships between water quality parameters, meteorological data, and whiteshrimp features. The observed values in the new data features are matched with the nodes (variables) in the shrimp aquaculture monitoring model. This includes water quality parameters, meteorological data, and whiteshrimp features.

Inference and Prediction: the shrimp aquaculture monitoring model is used for inference to estimate the growth and health status trends of the whiteshrimps. The specific inference method is conditional probability calculation.

According to Bayes rules, the conditional probability calculation is expressed as follows:

$$p ( v = a \vert E ) = \frac{p ( E , v = a )}{p ( E )}$$

where E represents features of new data, which predicts a probability of node ν taking a certain value α.

The above is only a specific embodiment of the disclosure, but the scope of protection of the disclosure is not limited to this. Those skilled in the art familiar with the technical field should be included in the scope of protection of the disclosure by equivalent substitution or modification based on the technical solution and inventive concept disclosed in the disclosure.

What is claimed is:

1. A method for aquaculture monitoring whiteshrimp based on multimodal data fusion, comprising:
collecting a dataset, wherein the dataset comprises: aquaculture environment data and whiteshrimp images, the whiteshrimp images comprise whiteshrimp individual images and whiteshrimp group images, each of the whiteshrimp individual images contains one whiteshrimp, and each of the whiteshrimp group images contains at least two whiteshrimps;
extracting the dataset to obtain features of the whiteshrimp images and features of the aquaculture environment data, and performing feature fusion on the features of the whiteshrimp images and the features of the aquaculture environment data to obtain multimodal fusion features;
constructing a shrimp aquaculture monitoring model based on the multimodal fusion features by using a Bayesian network model; and
monitoring shrimp aquaculture conditions based on the shrimp aquaculture monitoring model.

2. The method for aquaculture monitoring the whiteshrimp based on the multimodal data fusion as claimed in claim 1, wherein the aquaculture environment data comprises water quality parameters and meteorological parameters, the water quality parameters comprise a water temperature, a dissolved oxygen content, a hydrogen ion concentration (pH) value, an ammonia nitrogen level, a nitrate level, and a turbidity, and the meteorological parameters comprise an air temperature, an air pressure, and a humidity.

3. The method for aquaculture monitoring the whiteshrimp based on the multimodal data fusion as claimed in claim 1, wherein the extracting the dataset to obtain features of the whiteshrimp images and features of the aquaculture environment data further comprises preprocessing the dataset, and
the preprocessing the dataset comprises: performing data cleaning, missing value processing, and format converting on the dataset.

4. The method for aquaculture monitoring the whiteshrimp based on the multimodal data fusion as claimed in claim 1, wherein the performing feature fusion on the features of the whiteshrimp images and the features of the aquaculture environment data to obtain multimodal fusion features comprises:
fusing the features of the whiteshrimp images and the features of the aquaculture environment data based on a multi-layer perceptron (MLLP) method.

5. The method for aquaculture monitoring the whiteshrimp based on the multimodal data fusion as claimed in claim 1, wherein the extracting the dataset to obtain features of the whiteshrimp images comprises extracting the dataset by using a deep convolutional neural network to obtain the whiteshrimp individual images and the whiteshrimp group images.

6. The method for aquaculture monitoring the whiteshrimp based on the multimodal data fusion as claimed in claim 1, wherein the extracting the dataset to obtain features of the aquaculture environment data comprises extracting the dataset to obtain the features of the aquaculture environment data by using principal a component analysis and wavelet thresholding method.

7. The method for aquaculture monitoring the whiteshrimp based on the multimodal data fusion as claimed in claim 1, wherein the constructing a shrimp aquaculture monitoring model based on the multimodal fusion features by using a Bayesian network model comprises:
determining an input data, comprising: using the multimodal fusion features as the input data for model training;
analyzing and determining network nodes and connecting edges of the Bayesian network model based on expert knowledge and the input data, thereby obtaining a topology of the Bayesian network model;
estimating parameters of the Bayesian network model by using maximum a posteriori method; and
optimizing the topology and the parameters of the Bayesian network model to obtain the shrimp aquaculture monitoring model.
